(19) United States
(12) Patent Application Publication
(10) Pub. No.: US 2006/0155518 A1
(43) Pub. Date: Jul. 13, 2006

(54) Method for retrievably storing audio data in a computer apparatus

(76) Inventor: Robert Grabert, Berlin (DE)

Correspondence Address: SMITH PATENT OFFICE, 1901 PENNSYLVANIA AVENUE N W, SUITE 901, WASHINGTON, DC, 20006, US

(21) Appl. No.: 11/184,084

(22) Filed: Jul. 19, 2005

(30) Foreign Application Priority Data
Jul. 21, 2004 (DE) 10 2004 035 244.5

(51) Int. Cl. G06F 17/50

(52) U.S. Cl. 703/1

(57) ABSTRACT

The invention relates to a method for retrievably storing audio data in a computer apparatus on which a CAD application program is installed in executable form. The method involves a voice input from the user being stored using generated audio data in a memory device in the computer apparatus. The audio data are associated with a selected point in a CAD drawing using an electronic association, so that the stored audio data can be retrieved using a voice input application subprogram when the selected point is marked later.

The invention relates to a method for retrievably storing audio data in a computer apparatus on which a CAD (Computer Aided Design) application program is installed in executable form.

CAD application programs are used to process drawings of any kind with the aid of a computer. The drawings can be edited in any way using the CAD application program which is used. By way of example, the editing steps include creating new drawings, altering existing drawings or else replicating drawings. CAD application programs are used in a wide variety of engineering fields, for example in connection with architectural drawings or mechanical engineering drawings.

It is an object of the invention to expand the opportunities of use for a CAD application program and to improve the userfriendliness for the user of the CAD application program.

The invention achieves this object by means of a method in accordance with independent claim 1.

The invention provides a method for retrievably storing audio data in a computer apparatus on which a CAD application program is installed in executable form, where the method comprises the following steps:
a drawing containing drawing elements is shown within a plotting area on a screen area, which the computer apparatus comprises, when the CAD application program is executed;
the user's selection of an audio application program installed on the computer apparatus is detected by the control device;
a voice input mask is output on the screen area by the audio application program;
a control device which the computer apparatus comprises is used to detect a marker for a point on or next to the drawing elements which has been selected by a user using an input device which the computer apparatus comprises, the position of said point on the plotting area being defined by means of associated coordinate data,
the audio application program is used to generate audio data in line with a voice input which is detected by means of a microphone device which the computer apparatus comprises; and
the audio data are stored in a memory device which the computer apparatus comprises, as is an electronic association between the audio data and the selected point defined by means of associated coordinate data; so that the audio data can be reproduced by means of the audio application subprogram when the selected point is marked again.

The method proposed provides the user of the CAD application program with the opportunity to store any additional information as audio data in connection with a drawing element from the edited drawing in the computer apparatus. Whereas when an ordinary CAD application program is used only the drawing elements can be electronically stored as information about the article which has been drawn, the user can use the proposed method to store additional information for drawing elements such that the additional information is associated with points and/or drawing elements in the drawing edited using the CAD application program. By way of example, this is advantageous in a situation in which an architect on a building site is using the CAD application program on the computer apparatus to draw outlines of rooms or buildings. In this case, the architect can use voice input for electronically storing additional information relating to the rooms/buildings for individual drawing elements, for example for a wall which has been drawn, for example details about the physical state of walls. A drawing element in the CAD drawing for which audio data are being stored may in this case even be a blank drawing section in the plotting area, for example if it is the surroundings of a building which are having additional information stored for them in the form of audio data. When the architect then writes a report about the inspection at a later time in the office, he can use the stored audio data, which for their part are associated with points and/or drawing elements in the CAD drawing generated on the building site.

A further advantage of the method provided is that userfriendliness is improved for the user of the CAD application program. The user no longer needs to use a dictaphone to record voice information in addition to the computer apparatus with the CAD application program. During such voice recording, the user needs to ensure in suitable fashion that the drawing in the CAD application program and the voice inputs on the dictaphone are correlated to one another, for example by dictating information about the associated drawing element for each voice input. This complexity is dispensed with.

One expedient refinement by the inventors involves a graphical audio data symbol being generated and shown next to the selected point on the plotting area, which indicates that the selected point has associated audio data stored for it. As a result, a first thing is that when the drawing is shown on the screen area the user is immediately shown which drawing elements have associated existing audio data. In addition, the audio data symbol makes it easier for the user to mark when the associated audio data need to be reproduced.

One preferred development of the invention may have provision for the audio data to be reproduced on a loudspeaker device which the computer apparatus comprises after another instance of the audio application subprogram being selected and another instance of the selected point being marked by the user have been detected using the control device.

In one advantageous embodiment of the invention, the voice input function mask is used to output a user-editable text input field on the screen area, to detect a text input, to generate text data in line with the text input and store said text data in the memory device, with a further electronic association between the text data and the selected point defined by means of associated coordinate data additionally being generated and stored.

This means that the user is able to store, besides the voice information, additionally text for the selected point in the drawing, so that the text can be output on the screen area as additional information for the selected point after the selected point has been marked again.

One development of the invention may provide for the electronic association and/or further electronic association generated and stored to be an attribute assignment to the selected point.

The audio data and/or the text data are preferably stored as an EED (Extended Entity Data) addition to the selected point.

The invention is explained in more detail below using an exemplary embodiment with reference to a drawing, in which:

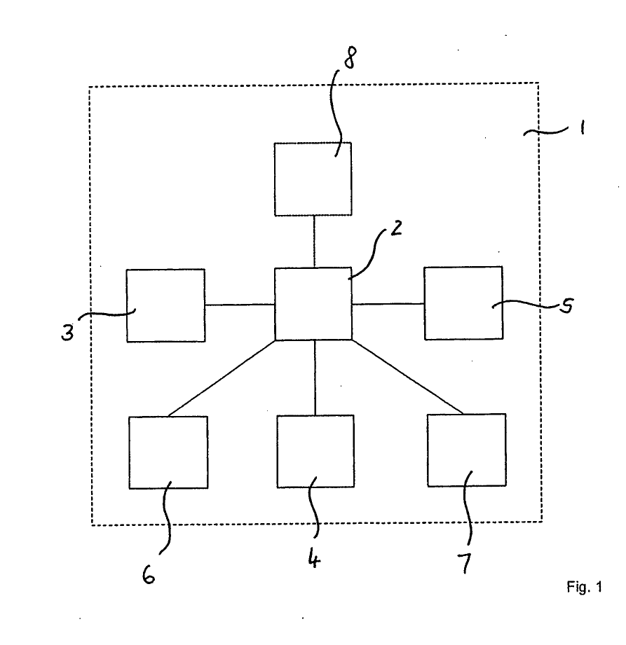

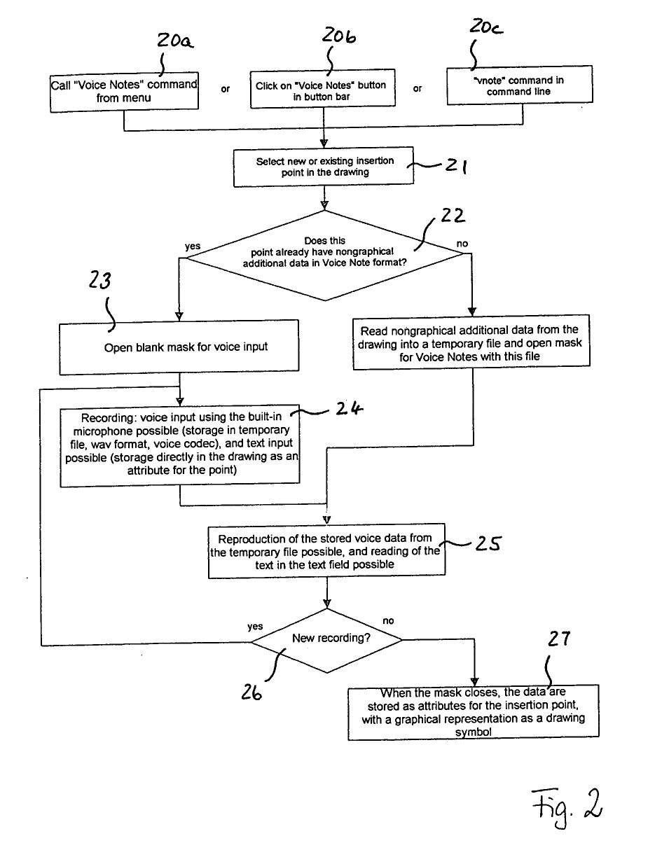

FIG. 1 shows a schematic illustration of a computer apparatus for using a CAD application program;

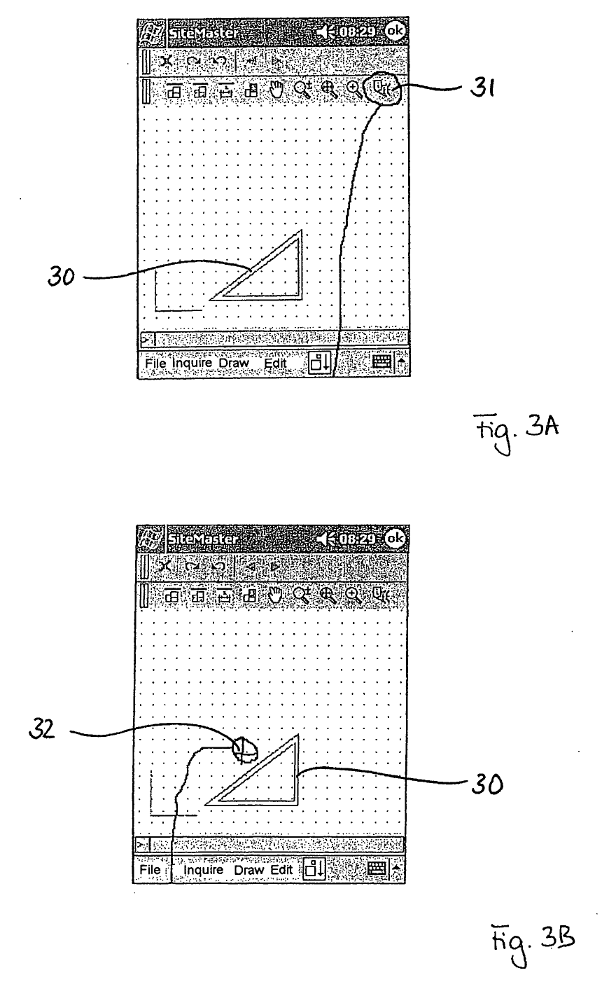

FIG. 2 shows a flowchart to explain a method for retrievably storing audio data in the computer apparatus shown in FIG. 1;

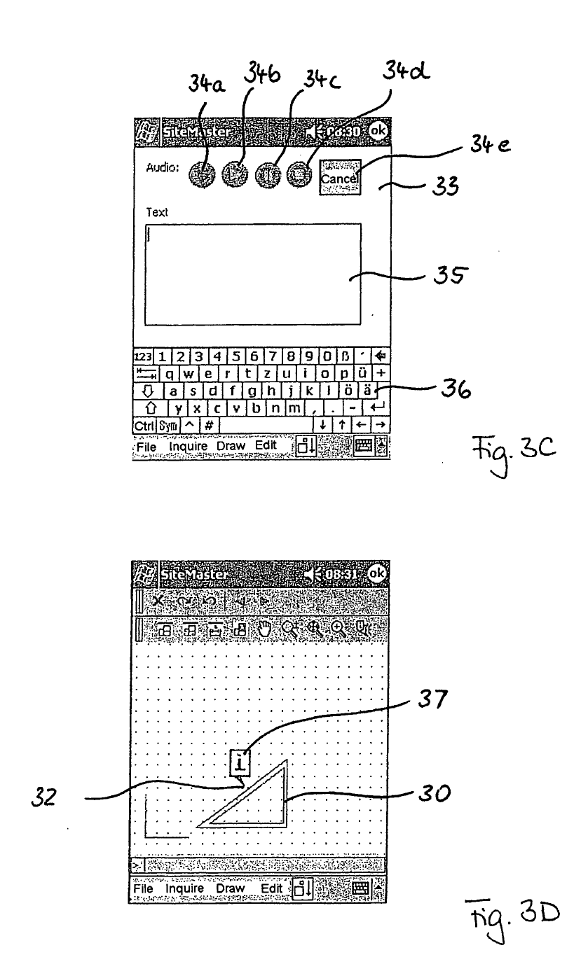

FIG. 3A-3D show screenshots on a screen device in the computer apparatus shown in FIG. 1 in the course of the method for retrievably storing audio data; and

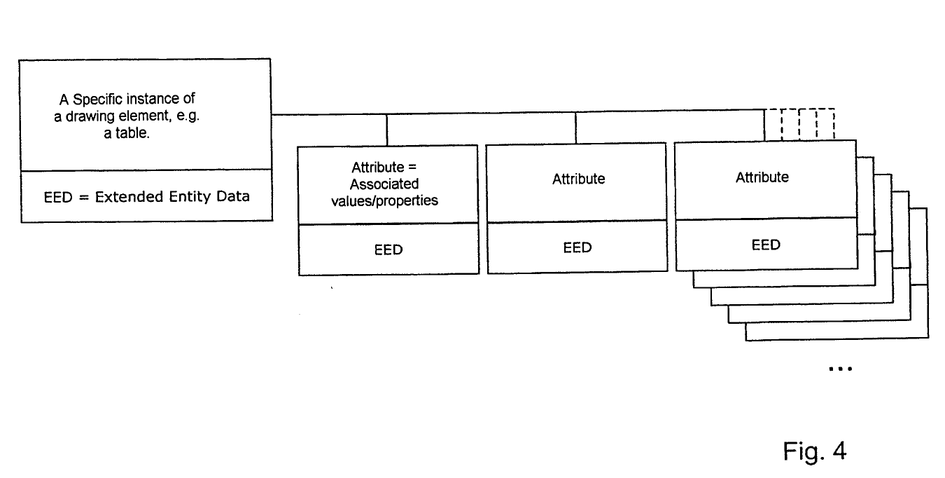

FIG. 4 shows a schematic illustration to explain the storage of audio data for a drawing object.

FIG. 1 shows a schematic illustration of a computer apparatus 1 with a control device 2 which is connected to a memory device 3, an input device 4 and a screen 5. The control device 2, which normally comprises processor means and a main memory, for example the central processing unit which is usual for computers, is used to coordinate the processes which take place on the computer apparatus during execution of software application programs. This relates particularly to the interchange of electronic data between the memory device 3, the input device 4, which may be a mouse and/or a keyboard, and the screen 5. The computer apparatus 1 also comprises a microphone 6 and a loudspeaker 7. In addition, further components may be connected, for example a replaceable memory 8. The computer apparatus 1 may be a portable appliance, for example a pocket computer. Alternatively, the computer apparatus 1 may also be in the form of a “desktop” computer.

The computer apparatus 1 has a CAD (Computer Aided Design) application program installed on it which can be used to create and edit drawings on the basis of electronic data, as is known generally for such programs. The text below gives a more detailed description of a method for retrievably storing audio data in the computer apparatus 1 with reference to FIGS. 2 and 3A-3D. FIG. 2 shows a flowchart to explain the method. FIG. 3A-3D show various screenshots which are shown to the user of the computer apparatus 1 on a screen area of the screen 5 in the course of the method.

When the CAD application program installed on the computer apparatus 1 has been started, the user uses the available function elements in the CAD application program to draw an article 30, as is shown in FIG. 3A. If the user now wishes to store additional information for the article 30 which has been drawn electronically in the form of a voice message, he uses the input device 4 to select an audio application subprogram “Voice Notes” from 20a, 20b, 20c (cf. FIG. 2). In the example shown in FIG. 3A-3D, this is done by operating a button 31. In addition, in line with the audio application subprogram's expectation, the user marks a selected point 32 in the drawing with which the voice input to be recorded needs to be associated 21. As FIG. 3B shows, the selected point 32 is situated next to the article 30 which has been drawn. Alternatively, marking can be used to select a point which is situated on a section of the article 30 which has been drawn. As regards the sequence when detecting and storing the voice input, provision may also be made for the selected point 32 to be marked first and then for the audio application subprogram to be called.

When the selection of the audio application subprogram has been detected and the selected point 32 has been marked by the user, the control device 2 checks 22 whether the selected point 32 already has stored audio data stored in the memory device 3. If there are audio data which have already been stored, this is indicated to the user by virtue of the reproduction/recording length of the audio data being displayed on the screen 5. If this is not the case, the CAD application program outputs 23 a voice input mask 33 on the screen 5, as shown in FIG. 3C. The voice input mask 33 comprises functional elements 34a-34e, as are known as user fields in connection with voice input/reproduction programs or else on voice recording equipment. The user can use the input device 4 to operate the functional elements 34a-34e in order to record 24 a voice input. In this context, the microphone 6 is used to detect the voice input.

As FIG. 3D shows, the input mask 33 is additionally used to provide the user with an editable text input field 35 on the screen 5. Using a screen keyboard 36 which is likewise shown or using the input device 4, the user can input a text which comprises additional information for the selected point 32.

When the voice input has been recorded and/or the text input has been captured, associated audio data/text data are stored 25 in the memory device 3 as belonging to the selected point 32. In the exemplary embodiment shown, recorded audio data are stored in EED (Extended Entity Data) format as an attribute for the drawing element in question, as shown schematically in FIG. 4. EED may be of any volume in principle. In certain CAD environments, they are limited to 16 kbytes, however. For reasons of compatibility, the audio data are split over blocks of 16 kbytes in size and are packed into EED. EED are used as a kind of container. In this way, it is possible to store attachments of any size for an insert.

As FIG. 3D shows, a graphical symbol 37 is shown in the drawing in the region of the selected point 32 after the audio data and/or the text data have been stored. Upon later remarking of the selected point 32, for example by means of selection of the graphical symbol 37, and of the audio application subprogram, the stored audio data can be output on the loudspeaker 7. If stored text data exist for the selected point 32, these data are shown in the text input field 34.

The audio application subprogram which has then been activated then allows the user to record a fresh voice input 26. If he does not wish to do this, the voice input mask 33 is closed 27.

The features of the invention which are disclosed in the description above, in the claims and in the drawing can be significant either individually or in any combination for implementing the invention in its various embodiments.

1. A method for retrievably storing audio data in a computer apparatus on which a CAD application program is installed in executable form, where the method comprises the following steps:
a drawing containing drawing elements is shown within a plotting area on a screen area, which the computer apparatus comprises, when the CAD application program is executed;
the user's selection of an audio application program installed on the computer apparatus is detected by the control device;
a voice input mask is output on the screen area by the audio application program;
a control device which the computer apparatus comprises is used to detect a marker for a point on or next to the drawing elements which has been selected by a user using an input device which the computer apparatus comprises, the position of said point on the plotting area being defined by means of associated coordinate data,
the audio application program is used to generate audio data in line with a voice input which is detected by means of a microphone device which the computer apparatus comprises; and
the audio data are stored in a memory device which the computer apparatus comprises, as is an electronic association between the audio data and the selected point defined by means of associated coordinate data; so that the audio data can be reproduced by means of the audio application subprogram when the selected point is marked again.

2. The method as claimed in claim 1, wherein a graphical audio data symbol is generated and shown in the region of the selected point on the plotting area, which indicates that the audio data associated with the selected point has been stored.

3. The method as claimed in claim 1, wherein the audio data are reproduced on a loudspeaker device which the computer apparatus comprises after another instance of the selected point being marked and another instance of the audio application subprogram being selected by the user have been detected using the control device.

4. The method as claimed in claim 1, wherein the voice input mask is used to output a user-editable text input field on the screen area, to detect a text input, to generate text data in line with the text input and store said text data in the memory device, with a further electronic association between the text data and the selected point defined by means of associated coordinate data additionally being generated and stored.

5. The method as claimed in claim 4, wherein at least one of the electronic association and further electronic association generated and stored is an attribute assignment to the selected points.

6. The method as claimed in claim 4, wherein the audio data and/or the text data are stored as an EED (Extended Entity Data) addition to the selected point.

7. The method as claimed in claim 2, wherein the audio data are reproduced on a loudspeaker device which the computer apparatus comprises after another instance of the selected point being marked and another instance of the audio application subprogram being selected by the user have been detected using the control device.
